(19) United States
(12) Patent Application Publication
(10) Pub. No.: US 2004/0237008 A1
(43) Pub. Date: Nov. 25, 2004

(54) Method for operating a circuit arrangement containing a microcontroller and an eeprom

(76) Inventor: Alexander Steinert, Tuebingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/489,410

(22) PCT Filed: Aug. 23, 2002
(86) PCT No.: PCT/DE02/03088

(30) Foreign Application Priority Data
Sep. 11, 2001 (DE) 101 44 617.9

(51) Int. Cl. G06F 11/00

(52) U.S. Cl. 714/701

(57) ABSTRACT

The invention relates to method for operating a circuit arrangement containing a microcontroller (10) and an EEPROM (11). After the execution of a predetermined number of storage processes of a data set in a data set memory (DA1, DA2, DA3; DB1, DB2, DB3) of EEPROM (11), the data set is stored in another data set memory (DA1, DA2, DA3; DB1, DB2, DB3). The inventive method makes it possible to eliminate the problem associated with being able to conduct, due to technical constraints, only a limited number of storage processes in a designated storage cell of an EEPROM (11).

The invention is based upon a method of operating a circuit arrangement which includes a microcontroller and an EEPROM [electrically erasable programmable read only memory] in accordance with the preamble of the independent claim.

From DE-A 19 71 6520, a method according to the preamble of the independent claim has become known by means of which the operating parameters of an electric motor can be acquired. Especially the operating duration [operating hours] can be stored. For long-term storage, a PROM [programmable read only memory], an EPROM [erasable programmable read only memory] or an EEPROM [electrically erasable programmable read only memory] can be provided. With a PROM the data set which is supplied can be stored by irreversible programming of the PROM storage cells. An EPROM can allow the erasure of the storage content at the end of a new use cycle and then reuse. Since both memory types allow the storage of a data set within the same storage [memory] cells only once during a use cycle, numerous storage cells must be reserved for example as use as an operating duration counter.

The most flexible solution utilizes an EEPROM whose storage cells can be written to electrically and have erasable contents. The advantage of the use of an EEPROM, however, can be enjoyed only with certain drawbacks. The storage cells of an EEPROM cannot, for technical reasons, be written to an optionally large number of times. The number of memory processes is, for example, limited to about 10,000. A further problem arises when during the storage process for the EEPROM, there is an interruption in the operating voltage. In this case, the contents of the memory cells to be written to can pass into an undefined stage with the consequence that an erroneous data set will be stored.

The invention has as its object to provide a method of operating a circuit arrangement which includes a microcontroller and an EEPROM in which the technically determined limits of the number of writing or storage processes can be overcome.

This object is achieved by the features set forth in the independent claim.

### ADVANTAGES OF THE INVENTION

The method of the invention provides that, respectively, after a predetermined number of storage processes of data sets in a data set memory of an EEPROM, the data set is stored in another data set memory. With this feature it can be ensured that the maximum number of storage processes in one and the same storage cell of an EEPROM will not be exceeded and nevertheless the required number of storage processes for a data set can be ensured.

Advantageous features and refinements of the method according to the invention are given in the dependent claims.

An especially advantageous feature of the invention according to the method of the invention foresees a storage of an offset data set in an offset data store. The currently valid address of the data set memory can thus in the simplest possible way be read out of the offset data set memory. With the offset data set, the microcontroller has available at any point in time, especially after a start, the data set which is then effective.

An advantageous refinement provides that the number of storage processes is detected using the data set itself. With this feature an especially simple realization of the offset data set memory is possible in that it can be identical with the data set memory.

An especially advantageous feature provides that in the EEPROM, a first and at least one second memory regions are provided for storage of the data set. Furthermore, a third memory region is provided in the EEPROM which contains a pointer indicating the currently effective memory region. The microcontroller stores in a prior program step the data set in the ineffective memory region and modifies in a subsequent program step the pointer so that the ineffective memory region becomes the effective memory region.

These two program steps are cyclically repeated. An important advantage of this feature of the method according to the invention is that in each operating state an effective data set can be found in one of the at least two memory regions. A defect in the course of operation, especially a shut off of the voltage supply during a writing process into the EEPROM has the consequence that a storage procedure for a data set will be defective but this has no detrimental effect upon the correctly registered data set in the other memory region. Thus at any time it is possible to refer back to the last stored correctly registered data set in the other memory region.

Another advantageous feature provides for the incorporation of a reset arrangement in the method according to the invention.

A detected failure in the program operation or a start up of the circuit arrangement triggers a reset. According to the invention it is provided that the microcontroller after a reset in a starting step reads the offset data store to enable the currently effective data set memory. To the extent that the data set memory according to the aforedescribed advantageous features is subdivided into a plurality of memory regions, in another starting step, the pointer is read out to indicate the then effective memory region.

The method of the invention is especially suitable for circuit arrangements in which the operating voltage may be shut off or turned on at any time by a user. Since the pointer in combination with the offset data memory enables the microcontroller, after a reset, to always return to a correctly stored data set, the further process steps also have a correct data set as their basis.

Because to the sequential mode of operation of the microcontroller, it is possible to exclude a condition under which more than one memory process will erroneously be carried out. A correct data set memorized in at least a preceding cycle is always available in every case after a reset.

Another advantageous feature provides a timer which influences the storage of the data set from a timing point of view. To the extent that the data set is altered prior to any memory process, with this feature in a simple manner an operating time counter can be provided. The timer can also control the cyclical repetition of the program steps for storing the data set in the respective memory region which is ineffective. The inner can be contained in the microcontroller.

The feature of the method of the invention whereby a multiplicity of memory regions and the pointer are used, ensures that, upon a defective storage process, a data set reproducing the operating time in a memory region will not give rise to a loss of the information representing the operating time since, upon a reset, the stored correct data set previously registered in another memory region can be recovered.

The method of the invention is especially suitable, for use for devices in a motor vehicle. When storage of data sets are carried out every ten seconds, the number of permissible storage processes, for example 10,000, can be reached after an operating time of only about 28 hours. The process of the invention thus with a simple approach can solve this problem so that operating times of several thousand hours can be achieved as is relevant for motor vehicles.

Because the electrical energy is only limitedly available in the shut down state of a motor vehicle, it is further of advantage for the circuit arrangement to be able to be completely shut off. An error which may thus be stored in a data set during the shut down has no further effect since upon restart, the last correctly stored data set will be referred to.

One possibility of use of the method of the invention in a motor vehicle is with an air quality sensor which can monitor the quality of the external air and provide the control signals for an air conditioning unit. Based upon the operating time counter, both short term and long term corrections of the sensor signals can be undertaken.

Further advantageous refinements of the method of the invention are given in the additional dependent claims and in the following description.

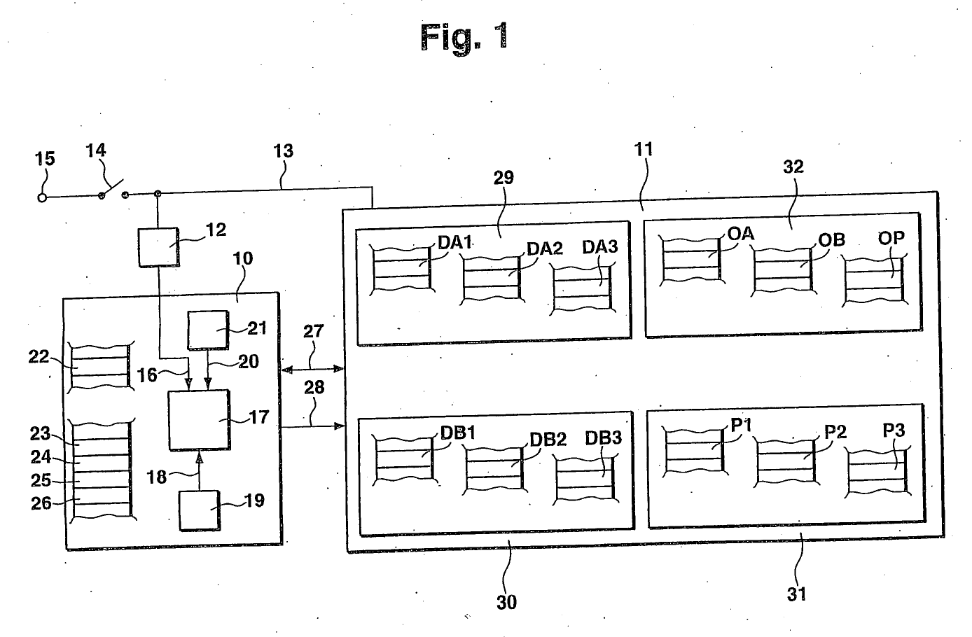

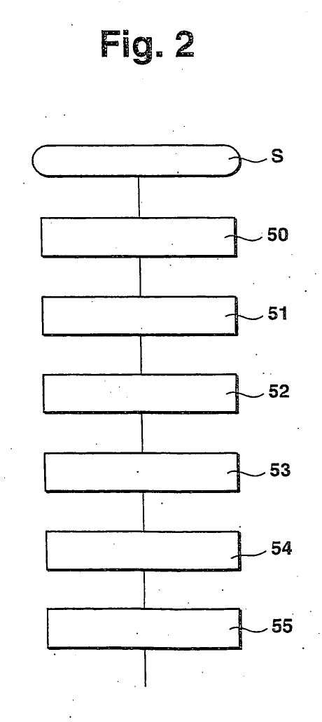

FIG. 1 shows a block circuit diagram of a circuit arrangement in which the method according to the invention runs in accordance with FIG. 2.

The circuit arrangement contains a microcontroller 10, an EEPROM 11 and a reset arrangement 12. Both the reset arrangement 12 and the EEPROM are connected with an electric current supply line 13 which is connectable with an energy source 15 through a switch 14.

The reset arrangement 12 issues a reset signal 16 to a processor core 17. The processor core 17 further feeds a clock signal 18 which is produced by a clock generator 19, as well as a timer signal 20 which is produced by a timer 21.

The controller 10 includes a reset memory 22, a data set memory 23, a pointer memory 24, an offset data set memory 25 as well as a pointer offset memory 26.

The microcontroller 10 communicates with the EEPROM 11 over a bidirectional data bus 27 as well as via an address bus 28.

The EEPROM 11 contains first, second, third and fourth memory regions 29, 30, 31, 32. The first memory region 29 contains a first, second and third data store DA1, DA2, DA3. The second memory region 30 likewise contains a first, second and third data set store DB1, DB2, DB3. The third memory region 31 contains a first, second and third pointers P1, P2, P3. The fourth memory region 32 contains a first and a second offset data store OA, OB as well as a pointer offset store OP.

FIG. 2 shows the method according to the invention which after a start S initiates a reset process in a first starting step 50. In a second starting step 51, a readout of the offset data store OA, OB is provided. In a third starting step 52, the pointer P1, P2, P3 is read out from the pointer offset memory OP as a function of the offset. In a fourth starting step 53, a data set is read out either from the first memory region 29 or from the second memory region 30 depending upon which of the memory regions 29, 30 is indicated by the pointer P1, P2, P3 as the currently effective memory region 29, 30.

In a first step 54, a data set is stored in one of the data set stores DA1, DA2 or DA3 or DB1, DB2, DB3 of the first or second memory regions 29, 30 which has been indicated as ineffective at the time. In a second step 55, the pointer P1, P2, P3 is altered so that the effective first or second memory region 29, 30 is indicated.

The method according to the invention for operating the circuit arrangement works in the following way:

Initially the electric current supply line 13 is connected by the switch 14 with the energy source 15, for example a battery. The reset arrangement which can be included in the microcontroller 10, produces the reset signal 16. The reset signal enables the microcontroller 10 to newly start a program sequence.

The information required for a reset, in general a starting address, is stored in the reset memory 23. The reset memory 23 is preferably contained in a ROM whose content is established by the manufacturer. The ROM can be contained in the microcontroller 10.

After the start S, the first starting step 50 is carried out and corresponds to the reset process.

The microcontroller 10 is connected by the data bus 27 and the address bus 26 with the EEPROM 11. The term EEPROM (electrically erasable programmable memory) is here used for a type of memory which does not lose its contents upon shut down of the operating voltage and has storage cells which can be written to a multiplicity of lines. The EEPROM can be contained in the microcontroller 10 which, in this case, can be called a mirocprocesseor.

In the third memory region 31 of the EEPROM 11, the pointer P1, P2, P3 is received. The pointer P1, P2, P3 is a data set which can indicate whether the first or second memory region 29, 30 of the EEPROM 11 is effective or ineffective. Preferably the pointer P1, P2, P3 is configured as a bit pointer so that only a single bit is required which can represent the state 0 or 1. In the configuration of the bit pointer, with for example a byte, the information is coded preferably as the lowest value bit.

Instead the pointer in the illustrated embodiment has first, second and third pointers P1, P2, P3. Which of the three pointers P1, P2, P3 contains the actual pointer information in a particular case is given by the second starting steps 51 in which the offset both for the pointers P1, P2, P3 ass well as for the particular data set store DA1, DA2, DA3 of the first memory region 29 or the data set store DB1, DB2, DB3 of the second memory region 30 is given.

The offset for the effective pointer P1, P2, P3 can be derived from the pointer offset store OP. The thus obtained effective pointer P1, P2, P3 can, from the effective offset data store OA, OB, provide a conclusion as to the address of the effective data set store DA1, DA2, DA3 of the first memory region 29 or the data set store DB1, DB2, DB3 of the second memory region 30.

In a configuration of the invention in which there is a saving in the stores provided, the offset stores OP, OA, OB can be eliminated. With the precondition that a corresponding distinction is possible, the effective address of one of the data set stores DA1, DA2, DA3 or data set stores DB1, DB2, DB3 can be read or determined directly therefrom. Optionally, the data set stores DA1, DA2, DA3 or DB1, DB2, DB3 at all reserved store locations can be interrogated and the contents thereof explored.

Based upon the offset information, it is possible to distinguish which of the pointers P1, P2, P3 contains the actual information. Instead of the three pointers P1, P2, P3 indicated, still further pointers can be included which differ only as to the different positions in the EEPROM 11. The basis for providing the different pointers P1, P2, P3 also rests in the limited number of times data can be written to one in the same store location in the EEPROM 11. Both the offset in the pointer offset store OP or the offset obtained from the data stores DA1, DA2, DA3 or the data set stores DB1, DB2, DB3 can be altered after a predetermined number of storage processes to another value which advances respectively to the next pointer P1, P2, P3. The pointer P1, P2, P3 thus “wanders” through the EEPROM 11.

Because of the limited number of storage processes in a predetermined storage cell, the respective pluralities of data set store DA1, DA2, DA3 or DB1, DB2, DB3 are provided for each of the data set memories. After a predetermined number of storage processes the data set store is altered among the data set stores DA1, DA2, DA3 or DB1, DB2, DB3 to another data set store. As with the pointer P1, P2, P3, here as well, preferably starting from a base address, an offset is added which preferably is registered in the offset data stores DA1, DA2, DA3 or DB1, DB2, DB3. The first offset data store OA contains the offset for the data stores DA1, DA2, DA3 in the first region memory 29 and the second DA1, DA2, DA3 or DB1, DB2, DB3 contains the data offset DB1, DB2, DB3 in the second memory region 30. To save offset data set stores OA, OB it is further possible to include the corresponding operation in and derive it from the data set stores DA1, DA2, DA3 or DB1, DB2, DB3 to the extent that they enable registration of such information and can distinguish it. The data set stores DA1, DA2, DA3 or DB1, DB2, DB3 likewise “wander” through the EEPROM 11.

To allow the number of storage processes to be derived from the registered data sets in a simple manner, the data sets before each storage process can be incremented or decremented. By way of further clarification, reference is made only to the first data set store DA1 in the first region memory region 29 and the first data set store DB1 in the second memory region 30. In dependence upon the program course, the processor core 17 adds to a data set 1 unit, for example one bit, and stores the thus registered new data set in either the first data set store DA1 or the first data set store DB1 depending upon which of the memory regions 29, 30 has been designated by the pointer P1 as ineffective. With respect to the pointers P1, P2, P3, in the subsequent description reference will be made exclusively to the pointer P1. The last stored data set cam be read by the processor core either from the data set store DA1 or from the data set store DB1 depending upon which data set store DA1, DB1 is designated as currently effective by the pointer P1 preferably in the microcontroller 10 a RAM memory is provided for this data set.

Preferably additional RAM memory is provided not only for the data set store 23 but also for the pointer set store 24, the data set store 25 and the pointer offset store 26.

The first step 54 in which a data set is stored in the first data set store DA1 DB1 of the memory region 29, 30 indicated to be ineffective, is followed by a second step 55 which is provided to alter the pointer P1 to a value which allows a data set to be stored in a different one of the memory regions 29, 30 than that and which is indicated to be the effective memory region 29, 30.

Instead of the two memory regions 29, 30 described in the example, further memory regions can be provided. The embodiment with only two memorization regions 29, 30 has the advance that the pointer P1, P2, P3 can be realized as a pointer which in the simplest case requires only one stored bit to be communicated and that assumes the value 0 or 1.

In further operation, the first and second steps 54 and 55 are cyclically repeated. Should at any point in time, for example by an opening of the switch 14, an error be introduced into the first data set store DA1, DB1, in any case there will be another data set available from the preceding cycle in the corresponding data set store DA1, DB1 because the bit pointer P1 remains to indicate the old effective data store DA1, DB1 with the correct commitment.

Should an error-containing memory process affect the pointer P1, it will have no affect upon the data in the data set stores DA1, DB1.

Following each shut down of the operating voltage in the electric current supply line 13, either by the switch 14 or from some other event, the reset circuit 12 is activated and produces the reset signal 16. Upon initialization of the microcontroller 10, the pointer P1 is read out in the previously described third starting step 52 and in the fourth starting step 53, the data set is read out of the data set stores DA1, DA2, DA3 or DB1, DB2, DB3 of the effective memory region 29, 30 and the program sequence is based thereon.

An especially advantageous application is as an operating time counter. For this purpose the timer 21 ensures that a storage of the data set in the data store DA1, DA2, DA3 or DB1, DB2, DB3 is effected at predetermined times fixed by the timer 21. The timing is determined by means of the clock generator 19 of the microcontroller 10 which preferably is a quartz generator and by means of the timer 21. The clock cycle of for example ten seconds enables a counter to count a maximum duration of about 46603 hours with three byte binary storage cells. In this example at each 20 seconds a data set is stored and if the number of permissible data processes in a data set store DA1, DA2, DA3 or DB1, DB2, DB3 is for example 10000, that number is reached after an operating duration of only about 28 hours. Because of the provision of multiplicity of data stores DA1, DA2, DA3 or DB1, DB2, DB3, the mentioned storage duration of 46603 hours can be reached with reservation of a corresponding number of data set stores DA1, DA2, DA3 or data set stores DB1, DB2, DB3.

A data loss which can arise because of a defective storage process is to be avoided under all circumstances in an operating time counter. The subdivision of the data set stores DA1, DA2, DA3 or DB1, DB2, DB3 into a first and at least one second memory region 29, 30 ensures that there will always be a correct data set with the correct operating time available.

The method of the invention is especially suitable for use for devices which are built into an automotive vehicle. In this application in the shut down state of the vehicle only a limited amount of energy is available for operating the circuit arrangement so that the possibility of complete shut down of the short arrangement by means of the switch 14 is advantageous.

The method of the invention enables the registry of any optional operating time independently of the permissible number of storage processes in any specific storage cells of the EEPROM 11.

The method of the invention enables in spite of the complete shut down possibilities and the data errors which can occur in the storage process in the EEPROM during a shut down fully a reliable operation of the circuit arrangement. Preferred use in an automobile vehicle is as an air quality sensor in which the operating time counter can be used to correct the signals with respect to short term and long term fluctuations.

1. A method of operating a circuit arrangement which contains a microcontroller (10) and an EEPROM (11), characterized in that after a predetermined number of storage processes of a data set in one data set store (DA1, DA2, DA3; DB1, DB2, DB3) the data sets are stored in another data set store (DA1, DA2, DA3; DB1, DB2, DB3) of the EEPROM (11).

2. The method according to claim 1, characterized in that a storage of an offset data set is provided from which the address of the data store (DA1, DA2, DA3; DB1, DB2, DB3) can be determined.

3. The method according to claim 1 characterized in that the number of storage processes is determined from the data set.

4. The method according to claim 1, characterized in that the offset data set is identical to the data set stored in the data set store (DA1, DA2, DA3; DB1, DB2 DB3).

5. The method according to claim 1, characterized in that the EEPROM (11) a first and at least one second memory region (29, 30) for the data set stores (DA1, DA2, DA3; DB1, DB2, DB3) are provided, in that a third memory region is provided which contains a pointer (P1, P2, P3) indicating the effective memory region (29, 30), in that the microcontroller (10) in a first step (54) stores a data set in the ineffective memory region (29, 30) and in a second subsequent step (55) changes the pointer (P1, P2, P3) so that the ineffective memory region (29, 30) becomes the effective memory region, and in that both steps (54, 55) are cyclically repeated.

6. The method according to claims 5, characterized in that the microcontroller (10) before the two steps (54, 55) reads out in a starting step (52) after a reset, the pointer (P1, P2, P3) and in a further starting step (53) the data set from the effective memory region (29, 30).

7. The method according to claim 1, characterized in that the data set before each storage is incremented or decremented.

8. The method according to claim 1, characterized in that the data set is stored after a duration fixed by a timer (21).

9. The method according to claim 8, characterized in that the data set corresponds to an operating time counter.

10. The use of the method according to claim 1 for a device in a motor vehicle.

11. The use of the method according to claim 10 in an air quality sensor.
